(19) United States
(12) Patent Application Publication
(10) Pub. No.: US 2025/0244139 A1
(43) Pub. Date: Jul. 31, 2025

(54) DETERMINING A SET OF GEOGRAPHIC POSITION TRACES TO BE USED TO PRODUCE A DIGITAL MAP OF A REGION OF INTEREST

(71) Applicant: Toyota Jidosha Kabushiki Kaisha, Toyota-shi Aichi-ken (JP)

(72) Inventor: Eitan Gilad Mendelowitz, Northampton, MA (US)

(21) Appl. No.: 18/428,438

(22) Filed: Jan. 31, 2024

(51) Int. Cl. G01C 21/00

(52) U.S. Cl. CPC G01C 21/3811; G01C 21/387

(57) ABSTRACT

A system for determining a set of geographic position traces to be used to produce a digital map of a region of interest can include a processor and a memory. The memory can store a set determination module, a production module, and a communications module. The set determination module can determine, from geographic position traces of vehicles that traversed the region of interest, the set of geographic position traces to be used to produce the digital map of the region of interest. A count of the geographic position traces in the set can be based on an aspect, in the region of interest, to be included in the digital map. The production module can produce, from the set, the digital map. The communications module can transmit the digital map to a specific vehicle to be used to control movement of the specific vehicle.

### TECHNICAL FIELD

The disclosed technologies directed to determining a set of geographic position traces to be used to produce a digital map of a region of interest.

### BACKGROUND

A digital map can be an electronic representation of a conventional paper road map. For example, an automotive navigation system can use information received from a digital map and information received from a global navigation satellite system (GNSS) to produce a turn-by-turn navigation service. A turn-by-turn navigation service can provide a route between an origination point and a destination point. A position of a vehicle determined by such a turn-by-turn navigation service can be within a meter of an actual position.

More recently, technologies have been developed to automate one or more operations of one or more vehicle systems to control movement of a vehicle. Such technologies can use information received from a digital map to control such movement. However, such a digital map can be required to indicate positions of objects with a degree of accuracy that is within a decimeter. Accordingly, development of technologies to automate control of movement of vehicles have been accompanied by efforts to improve the degree of accuracy of digital maps. This has led to the production of high-definition (HD) maps.

An HD map can be a digital map that includes additional information to improve the degree of accuracy required to automate control of movement of a vehicle. An HD map can be characterized as having layers of additional information. Each layer of additional information can be affiliated with a specific category of additional information. These layers can include, for example, a layer of a base map, a layer of a geometric map, and a layer of a semantic map. The base map, the geometric map, and the semantic map can include information about static aspects of a location.

The geometric map can be produced, for example, using a simultaneous localization and mapping (SLAM) technique. A SLAM technique can use proprioception information to estimate a pose (i.e., a position and an orientation) of a vehicle, and perceptual information to correct an estimate of the pose. Usually, the proprioception information can be one or more of GNSS information, inertial measurement unit (IMU) information, odometry information, or the like. For example, the odometry information can be a value included in a signal sent to a vehicle system (e.g., an accelerator). The perceptual information can often be one or more of point cloud information from a ranging sensor (e.g., a light detection and ranging (lidar) system), image data from one or more images from one or more image sensors or cameras, or the like. The geometric map can include, for example, a ground map of improved surfaces for use by vehicles and pedestrians (e.g., drivable surfaces (e.g., roads)), and voxelized geometric representations of three-dimensional objects at the location.

The semantic map can include semantic information about objects included at the location. The objects can include, for example, landmarks. A landmark can be, for example, a feature that can be easily re-observed and distinguished from other features at the location. The term landmark, in a context of indicating positions of objects with a degree of accuracy that is within a decimeter, can be different from a conventional use of the term landmark. For example, landmarks can include lane boundaries, road boundaries, road junctions (e.g., intersections, interchanges, etc.), crosswalks, bus lanes, parking spots, signs, signs painted on roads, traffic lights, or the like.

Because an HD map can be used to localize a vehicle, which can be performed to control movement of the vehicle, not only do positions of objects need to be indicated on the HD map with a high degree of accuracy, but also the HD map can be required to be updated at a high rate to account for changes in objects or positions of objects expected to be indicated on the HD map.

### SUMMARY

In an embodiment, a system for determining a set of geographic position traces to be used to produce a digital map of a region of interest can include a processor and a memory. The memory can store a set determination module, a production module, and a communications module. The set determination module can include instructions that, when executed by the processor, cause the processor to determine, from geographic position traces of vehicles that traversed the region of interest, the set of geographic position traces to be used to produce the digital map of the region of interest. A count of the geographic position traces in the set can be based on an aspect, in the region of interest, to be included in the digital map. The production module can include instructions that, when executed by the processor, cause the processor to produce, from the set, the digital map. The communications module can include instructions that, when executed by the processor, cause the processor to transmit the digital map to a specific vehicle to be used to control movement of the specific vehicle.

In another embodiment, a method for determining a set of geographic position traces to be used to produce a digital map of a region of interest can include determining, by a processor and from geographic position traces of vehicles that traversed the region of interest, the set of geographic position traces to be used to produce the digital map of the region of interest. A count of the geographic position traces in the set can be based on an aspect, in the region of interest, to be included in the digital map. The method can include producing, by the processor and from the set, the digital map. The method can include transmitting, by the processor, the digital map to a specific vehicle to be used to control movement of the specific vehicle.

In another embodiment, a non-transitory computer-readable medium for determining a set of geographic position traces to be used to produce a digital map of a region of interest can include instructions that, when executed by one or more processors, cause the one or more processors to determine, from geographic position traces of vehicles that traversed the region of interest, the set of geographic position traces to be used to produce the digital map of the region of interest. A count of the geographic position traces in the set can be based on an aspect, in the region of interest, to be included in the digital map. The non-transitory computer-readable medium can include instructions that, when executed by one or more processors, cause the one or more processors to produce, from the set, the digital map. The non-transitory computer-readable medium can include instructions that, when executed by one or more processors, cause the one or more processors to transmit the digital map to a specific vehicle to be used to control movement of the specific vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for determining a set of geographic position traces to be used to produce a digital map of a region of interest, according to the disclosed technologies.

FIG. 2 is a block diagram that illustrates an example of a system for determining a set of geographic position traces to be used to produce a digital map of a region of interest, according to the disclosed technologies.

FIG. 3 includes a flow diagram that illustrates an example of a method that is associated with determining a set of geographic position traces to be used to produce a digital map of a region of interest, according to the disclosed technologies.

FIG. 4 includes a block diagram that illustrates an example of elements disposed on a vehicle, according to the disclosed technologies.

### DETAILED DESCRIPTION

Simultaneous localization and mapping (SLAM) is a phrase that can refer to a technology that enables a mobile robot (e.g., an automated vehicle or an autonomous vehicle) to move through an unknown location while simultaneously determining a pose (i.e., a position and an orientation) of the vehicle at the location (i.e., localization) and mapping the location. Typically, a SLAM technique can operate over discrete units of time and use proprioception information to estimate a pose of the vehicle, and perceptual information to correct an estimate of the pose. Usually, the proprioception information can be one or more of global navigation satellite system (GNSS) information, inertial measurement unit (IMU) information, odometry information, or the like. For example, the odometry information can be a value included in a signal sent to a vehicle system (e.g., an accelerator). The perceptual information can often be one or more of point cloud information from a ranging sensor (e.g., a light detection and ranging (lidar) system), image data from one or more images from one or more image sensors or cameras, or the like.

For example, for a SLAM technique that uses point cloud information from a ranging sensor, the ranging sensor can provide the vehicle with distances and bearings to objects in the location and the SLAM technique can operate to identify salient objects as landmarks. For example, for a SLAM technique that uses image data from one or more images from one or more image sensors or cameras, which can be referred to as visual SLAM, distances and bearings to objects can be determined using a photogrammetric range imaging technique (e.g., a structure from motion (SfM) technique) applied to a sequence of two-dimensional images. Because a camera can be less expensive than a lidar device and more vehicles are equipped with cameras than with lidar devices, considerable effort has been expended to develop visual SLAM for use in producing geometric maps as layers of high-definition (HD) maps used to control movements of vehicles.

Moreover, although SLAM techniques were originally developed to operate in real-time (i.e., simultaneously localize and map), the use of SLAM techniques to produce geometric maps has led to the development of SLAM techniques that can operate in a setting other than in a moving vehicle. In such SLAM techniques, recordings of the proprioception information and the perceptual information can be used. Such SLAM techniques can be referred to as offline SLAM. By using the recordings of the proprioception information and the perceptual information, corrections to estimates of poses of a vehicle can be performed concurrently on one or more finite sequences of the discrete units of time over which the SLAM techniques were operated.

The recordings of the proprioception information and the perceptual information can be obtained, for example, by a set of vehicles (e.g., probe vehicles). A probe vehicle can be a vehicle that intentionally performs one or more passes through a location to obtain the recordings of the proprioception information and the perceptual information. A vehicle, of the set of vehicles, can use, for example, proprioception information (e.g., one or more of GNSS information, IMU information, odometry information, or the like) to estimate a pose (i.e., a position and an orientation) of a camera attached to the vehicle. For example, for a vehicle of the set of vehicles (e.g., the probe vehicles), a transmission of a batch of data, based on the proprioception information and the perceptual information, can be received in a specific duration of time. For example, the specific duration of time can be thirty seconds. For example, the transmission of the batch can be received at a specific communication rate. For example, the specific communication rate can be once per thirty seconds.

The disclosed technologies are directed to determining a set of geographic position traces to be used to produce a digital map of a region of interest so that even though a system that implements the disclosed technologies receives a relatively large amount of data both produced and communicated at a high rate (e.g., produced, for example, at ten hertz; and communicated, for example, once per thirty seconds), the system can produce, from this data, the digital map of the region of interest in a relatively short duration of time (e.g., less than thirty minutes). For example, a geographic position trace, of the geographic position traces: (1) can be for a vehicle of vehicles that traversed the region of interest and (2) can include a recording of a sequence of points. For example, the recording can include, for a point in the sequence of points, information about: (1) a position of the point and (2) a time at which the position was documented. A count of the geographic position traces in the set can be based on an aspect, in the region of interest, to be included in the digital map. For example, the aspect can include a specific road, specific lanes of the specific road, a road junction of the specific road and another road, specific directions of travel through the road junction, or the like. For example, the count of the geographic position traces in the set can be a count of the geographic position traces of the vehicles that traversed a subject of the aspect. For example, the count of the geographic position traces of the vehicles that traversed the subject of the aspect can be greater than a first threshold count (i.e., to include enough data so that the digital map can be produced with a high degree of accuracy). For example, the count of the geographic position traces of the vehicles that traversed the subject of the aspect can be less than a second threshold count (i.e., to set a limit on an amount of the data so that the digital map can be produced in a relatively short duration of time). The digital map can be produced from the set of the geographic position traces. The digital map can be transmitted to a specific vehicle to be used to control movement of the specific vehicle.

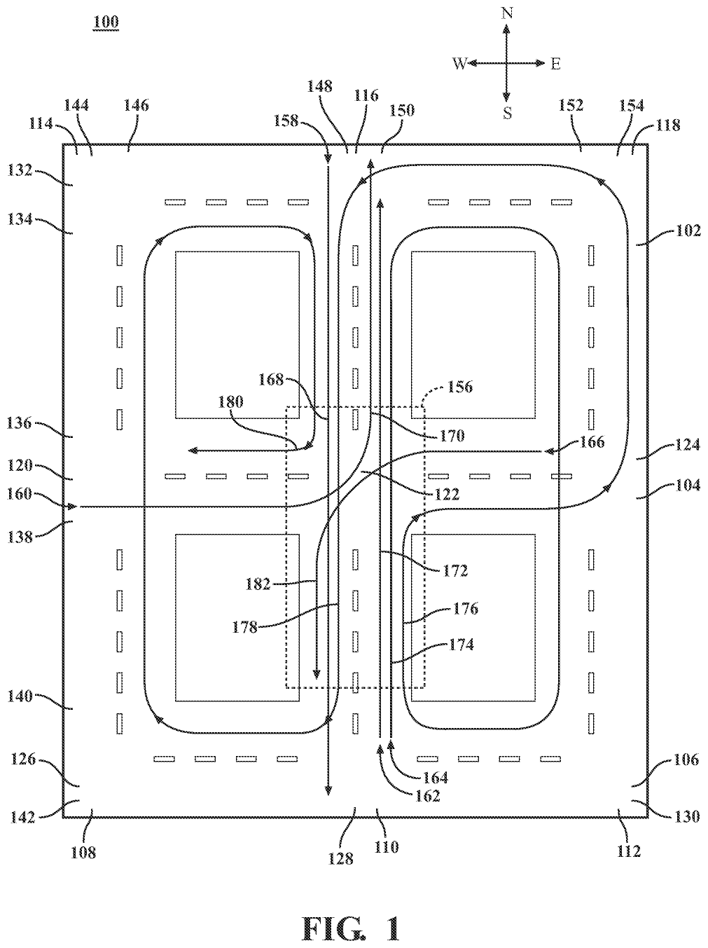

FIG. 1 includes a diagram 100 that illustrates an example of an environment for determining a set of geographic position traces to be used to produce a digital map of a region of interest, according to the disclosed technologies. For example, the diagram 100 can include First Street 102 (disposed along a line of latitude), Second Street 104 (disposed along a line of latitude, south of First Street 102), Third Street 106 (disposed along a line of latitude, south of Second Street 104), Avenue A 108 (disposed along a line of longitude), Avenue B 110 (disposed along a line of longitude, east of Avenue A 108), and Avenue C 112 (disposed along a line of longitude, east of Avenue B 110).

For example, the diagram 100 can include a first road junction 114 (of First Street 102 and Avenue A 108), a second road junction 116 (of First Street 102 and Avenue B 110), a third road junction 118 (of First Street 102 and Avenue C 112), a fourth road junction 120 (of Second Street 104 and Avenue A 108), a fifth road junction 122 (of Second Street 104 and Avenue B 110), a sixth road junction 124 (of Second Street 104 and Avenue C 112), a seventh road junction 126 (of Third Street 106 and Avenue A 108), an eighth road junction 128 (of Third Street 106 and Avenue B 110), and a ninth road junction 130 (of Third Street 106 and Avenue C 112).

For example, First Street 102 can include a westbound lane 132 and an eastbound lane 134, Second Street 104 can include a westbound lane 136 and an eastbound lane 138, Third Street 106 can include a westbound lane 140 and an eastbound lane 142, Avenue A 108 can include a southbound lane 144 and a northbound lane 146, Avenue B 110 can include a southbound lane 148 and a northbound lane 150, and Avenue C 112 can include a southbound lane 152 and a northbound lane 154. For example, the diagram 100 can include a region of interest 156 for which the digital map is to be produced. For example, the region of interest 156 can include: (1) a portion of Avenue B 110 south of the fifth road junction 122, but north of the eighth road junction 128 and (2) the fifth road junction 122.

For example, the diagram 100 can include a first geographic position trace 158, a second geographic position trace 160, a third geographic position trace 162, a fourth geographic position trace 164, and a fifth geographic position trace 166. Although one of skill in the art understands, in light of the description herein, that a geographic position trace includes a recording of a sequence of points, in the diagram 100, for illustrative purposes, each of the first geographic position trace 158, the second geographic position trace 160, the third geographic position trace 162, the fourth geographic position trace 164, and the fifth geographic position trace 166 is represented by a line.

For example, the first geographic position trace 158 can be of a vehicle that traversed the southbound lane 148 of Avenue B 110 from the second road junction 116 to the eighth road junction 128. For example, a portion 168 of the first geographic position trace 158 can be within the region of interest 156.

For example, the second geographic position trace 160 can be of a vehicle that traversed: (1) the eastbound lane 138 of Second Street 104 from the fourth road junction 120 to the fifth road junction 122 and (2) the northbound lane 150 of Avenue B 110 from the fifth road junction 122 to the second road junction 116. For example, a portion 170 of the second geographic position trace 160 can be within the region of interest 156.

For example, the third geographic position trace 162 can be of a vehicle that traversed the northbound lane 150 of Avenue B 110 from the eighth road junction 128 to the second road junction 116. For example, a portion 172 of the third geographic position trace 162 can be within the region of interest 156.

For example, the fourth geographic position trace 164 can be of a vehicle that traversed: (1) the northbound lane 150 of Avenue B 110 from the eighth road junction 128 to the second road junction 116, (2) the eastbound lane 134 of First Street 102 from the second road junction 116 to the third road junction 118, (3) the southbound lane 152 of Avenue C 112 from the third road junction 118 to the ninth road junction 130, (4) the westbound lane 136 of Third Street 106 from the ninth road junction 130 to the eighth road junction 128, (5) the northbound lane 150 of Avenue B 110 from the eighth road junction 128 to the fifth road junction 122, (6) the eastbound lane 138 of Second Street 104 from the fifth road junction 122 to the sixth road junction 124, (7) the northbound lane 144 of Avenue C 112 from the sixth road junction 124 to the third road junction 118, (8) the westbound lane 132 of First Street 102 from the third road junction 118 to the second road junction 116, (9) the southbound lane 148 of Avenue B 110 from the second road junction 116 to the eighth road junction 128, (10) the westbound lane 140 of Third Street 106 from the eighth road junction 128 to the seventh road junction 126, (11) the northbound lane 146 of Avenue A 108 from the seventh road junction 126 to the first road junction 114, (12) the eastbound lane 134 of First Street 102 from the first road junction 114 to the second road junction 116, (13) the southbound lane 148 of Avenue B 110 from the second road junction 116 to the fifth road junction 122, and (14) the westbound lane 136 of Second Street 104 from the fifth road junction 122 to the fourth road junction 120. For example, a first portion 174 of the fourth geographic position trace 164, a second portion 176 of the fourth geographic position trace 164, a third portion 178 of the fourth geographic position trace 164, and a fourth portion 180 of the fourth geographic position trace 164 can be within the region of interest 156.

For example, the fifth geographic position trace 166 can be of a vehicle that traversed: (1) the westbound lane 136 of Second Street 104 from the sixth road junction 124 to the fifth road junction 122 and (2) the southbound lane 148 of Avenue B 110 from the fifth road junction 122 to the eighth road junction 128. For example, a portion 182 of the fifth geographic position trace 166 can be within the region of interest 156.

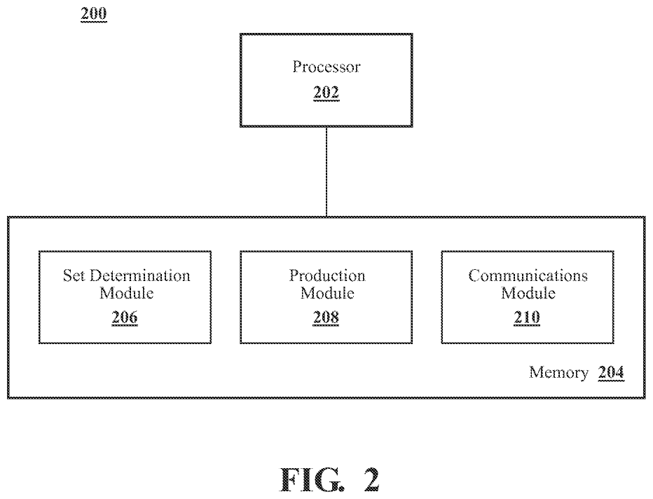

FIG. 2 is a block diagram that illustrates an example of a system 200 for determining a set of geographic position traces to be used to produce a digital map of a region of interest, according to the disclosed technologies. The system 200 can include, for example, a processor 202 and a memory 204. The memory 204 can be communicably coupled to the processor 202. For example, the memory 204 can store a set determination module 206, a production module 208, and a communications module 210.

For example, the set determination module 206 can include instructions that function to control the processor 202 to determine, from the geographic position traces of vehicles that traversed the region of interest, the set of the geographic position traces to be used to produce the digital map of the region of interest. For example, a count of the geographic position traces in the set can be based on an aspect, in the region of interest, to be included in the digital map.

For example, the production module 208 can include instructions that function to control the processor 202 to produce, from the set of the geographic position traces, the digital map.

For example, the communications module 210 can include instructions that function to control the processor 202 to transmit the digital map to a specific vehicle to be used to control movement of the specific vehicle.

For example, a geographic position trace, of the geographic position traces: (1) can be for a vehicle of the vehicles that traversed the region of interest and (2) can include a recording of a sequence of points. For example, the recording can include, for a point in the sequence of points, information about: (1) a position of the point and (2) a time at which the position was documented. For example, the position of the point can be expressed as a latitude of the point and a longitude of the point. For example, the position of the point can be a position of a camera disposed on the vehicle. Additionally, for example, the recording can further include, for the point, information about a height of the point with respect to a reference height. For example, the reference height can be sea level. For example, the position of the point can be determined from proprioception information affiliated with the vehicle. For example, the proprioception information can include one or more of global navigation satellite system (GNSS) information, inertial measurement unit (IMU) information, odometry information, or the like. For example, the sequence of points can include: (1) a first point as a first element and (2) a second point as a second element. For example, the sequence of points can be characterized by a duration of time between the first element and the second element. For example, the second element can be an element, in the sequence of points, that immediately follows the first element. For example, the duration of time can be affiliated with a specific production rate. For example, the specific production rate can be ten hertz. For example, the communications module 210 can further include instructions to receive, from the vehicle, the geographic position trace. For example, the geographic position trace can include a sequence of geographic position traces. For example, the sequence of geographic position traces can include: (1) a first geographic position trace as a first element and (2) a second geographic position trace as a second element. For example, the second element can be an element, in the sequence of geographic position traces, that immediately follows the first element. For example, the instructions to receive the geographic position trace can include instructions to receive, at a specific communication rate, the sequence of geographic position traces. For example, the specific communication rate can be once per thirty seconds.

In an implementation of the disclosed technologies, for example, the aspect, in the region of interest, can include a first road. For example, the set of the geographic position traces to be used to produce the digital map can include the geographic position traces of the vehicles that traversed the first road. For example, the count of the geographic position traces in the set can be a count of the geographic position traces of the vehicles that traversed the first road. For example, the count of the geographic position traces of the vehicles that traversed the first road can be greater than a first threshold count (i.e., to include enough data so that the digital map can be produced with a high degree of accuracy). Additionally, for example, the count of the geographic position traces of the vehicles that traversed the first road can be less than a second threshold count (i.e., to set a limit on an amount of the data so that the digital map can be produced in a relatively short duration of time).

With reference to FIG. 1, for example: (1) the region of interest can be the region of interest 156, (2) the first road can be the portion of Avenue B 110 south of the fifth road junction 122, but north of the eighth road junction 128, (3) the geographic position traces of the vehicles that traversed the first road can include: (a) the portion 168 of the first geographic position trace 158, (b) the portion 172 of the third geographic position trace 162, (c) the first portion 174 of the fourth geographic position trace 164, (d) the second portion 176 of the fourth geographic position trace 164, and (e) the third portion 178 of the fourth geographic position trace 164.

For example, if the first threshold count is two, then the count (i.e., five) of the geographic position traces of the vehicles that traversed the portion of Avenue B 110 south of the fifth road junction 122, but north of the eighth road junction 128 can include enough data so that the digital map can be produced with a high degree of accuracy. However, for example, if the second threshold count is five, then the count (i.e., five) of the geographic position traces of the vehicles that traversed the portion of Avenue B 110 south of the fifth road junction 122, but north of the eighth road junction 128 can exceed the limit on the amount of the data set so that the digital map can be produced in a relatively short duration of time).

For example, a geographic position trace: (1) can be included in the set of the geographic position traces and (2) can include a sequence of geographic position traces. For example, the sequence of geographic position traces can include a first geographic position trace and a second geographic position trace. For example, the first geographic position trace can be affiliated with a traversal during a first duration of time. For example, the second geographic position trace can be affiliated with a traversal during a second duration of time. For example, the second duration of time can lack an overlap with the first duration of time. For example, the count of the geographic position traces in the set can include: (1) the first geographic position trace as one count and (2) the second geographic position trace as another count.

With reference to FIG. 1, for example: (1) the first portion 174 of the fourth geographic position trace 164 can be one count, (2) the second portion 176 of the fourth geographic position trace 164 can be another count, and (3) the third portion 178 of the fourth geographic position trace 164 can be yet another count.

Additionally, for example, the aspect, in the region of interest, can further include: (1) a first lane of the first road and (2) a second lane of the first road. For example, the geographic position traces of the vehicles that traversed the first road can include a first subset and a second subset. For example, the first subset can include the geographic position traces of the vehicles that traversed the first lane. For example, the second subset can include the geographic position traces of the vehicles that traversed the second lane. For example, the count of the geographic position traces of the vehicles that traversed the first road can include a first count subset and a second count subset. For example, the first count subset can be a count of the geographic position traces of the vehicles that traversed the first lane. For example, the second count subset can be a count of the geographic position traces of the vehicles that traversed the second lane. For example, the count of the geographic position traces of the vehicles that traversed the first lane can be greater than a third threshold count. For example, the count of the geographic position traces of the vehicles that traversed the second lane can be greater than a fourth threshold count. For example, the fourth threshold count can be equal to the third threshold count. Additionally, for example, the count of the geographic position traces of the vehicles that traversed the first lane can be less than a fifth threshold count. Additionally, for example, the count of the geographic position traces of the vehicles that traversed the second lane can be less than a sixth threshold count. For example, the sixth threshold count can be equal to the fifth threshold count.

With reference to FIG. 1, for example: (1) the first lane of the first road can be the southbound lane 148, (2) the second lane of the first road can be the northbound lane 150, (3) the first subset can include: (a) the portion 168 of the first geographic position trace 158 and (b) the third portion 178 of the fourth geographic position trace 164, and (4) the second subset can include: (a) the portion 172 of the third geographic position trace 162, (b) the first portion 174 of the fourth geographic position trace 164, and (c) the second portion 176 of the fourth geographic position trace 164.

For example, if the third threshold count is zero, then the count (i.e., two) of the geographic position traces of the vehicles that traversed the portion of the southbound lane 148 of Avenue B 110 south of the fifth road junction 122, but north of the eighth road junction 128 can include enough data so that the digital map can be produced with a high degree of accuracy. Moreover, for example, if the fifth threshold count is three, then the count (i.e., two) of the geographic position traces of the vehicles that traversed the portion of the southbound lane 148 of Avenue B 110 south of the fifth road junction 122, but north of the eighth road junction 128 can be within the limit on the amount of the data set so that the digital map can be produced in a relatively short duration of time).

For example, if the fourth threshold count is zero, then the count (i.e., three) of the geographic position traces of the vehicles that traversed the portion of the northbound lane 150 of Avenue B 110 south of the fifth road junction 122, but north of the eighth road junction 128 can include enough data so that the digital map can be produced with a high degree of accuracy. However, for example, if the sixth threshold count is three, then the count (i.e., three) of the geographic position traces of the vehicles that traversed the portion of the northbound lane 150 of Avenue B 110 south of the fifth road junction 122, but north of the eighth road junction 128 can exceed the limit on the amount of the data set so that the digital map can be produced in a relatively short duration of time).

Alternatively or additionally, for example, the aspect, in the region of interest, can further include a road junction of the first road and a second road. For example, the geographic position traces of the vehicles that traversed the first road can include a subset. For example, the subset can include the geographic position traces of the vehicles that traversed the road junction. For example, the count of the geographic position traces of the vehicles that traversed the first road can include a count subset. For example, the count subset can be a count of the geographic position traces of the vehicles that traversed the road junction. For example, the count of the geographic position traces of the vehicles that traversed the road junction can be greater than a seventh threshold count. Additionally, for example, the count of the geographic position traces of the vehicles that traversed the first lane can be less than an eighth threshold count.

Additionally, for example, the aspect, in the region of interest, can further include: (1) a first direction of travel through the road junction and (2) a second direction of travel through the road junction. For example, the geographic position traces of the vehicles that traversed the road junction can include a first sub-subset and a second sub-subset. For example, the first sub-subset can include the geographic position traces of the vehicles that traversed the first direction of travel through the road junction. For example, the second sub-subset can include the geographic position traces of the vehicles that traversed the second direction of travel through the road junction. For example, the count of the geographic position traces of the vehicles that traversed the road junction can include a first count sub-subset and a second count sub-subset. For example, the first count sub-subset can be a count of the geographic position traces of the vehicles that traversed the first direction of travel through the road junction. For example, the second count sub-subset can be a count of the geographic position traces of the vehicles that traversed the second direction of travel through the road junction. For example, the count of the geographic position traces of the vehicles that traversed the first direction of travel through the road junction can be greater than a ninth threshold count. For example, the count of the geographic position traces of the vehicles that traversed the second direction of travel through the road junction can be greater than a tenth threshold count. For example, the tenth threshold count can be equal to the ninth threshold count. Additionally, for example, the count of the geographic position traces of the vehicles that traversed the first direction of travel through the road junction can be less than an eleventh threshold count. Additionally, for example, the count of the geographic position traces of the vehicles that traversed the second direction of travel through the road junction can be less than a twelfth threshold count. For example, the twelfth threshold count can be equal to the eleventh threshold count.

Additionally, for example, the aspect, in the region of interest, can further include a third direction of travel through the road junction. For example, the geographic position traces of the vehicles that traversed the road junction can further include a third sub-subset. For example, the third sub-subset can include the geographic position traces of the vehicles that traversed the third direction of travel through the road junction. For example, the count of the geographic position traces of the vehicles that traversed the road junction can further include a third count sub-subset. For example, the third count sub-subset can be a count of the geographic position traces of the vehicles that traversed the third direction of travel through the road junction. For example, the count of the geographic position traces of the vehicles that traversed the third direction of travel through the road junction can be greater than a thirteenth threshold count. For example, thirteenth threshold count can be equal to the ninth threshold count and the tenth threshold count. Additionally, for example, the count of the geographic position traces of the vehicles that traversed the third direction of travel through the road junction can be less than a fourteenth threshold count. For example, fourteenth threshold count can be equal to the eleventh threshold count and the twelfth threshold count.

With reference to FIG. 1, for example: (1) the region of interest can be the region of interest 156, (2) the road junction can be the fifth road junction 122, (3) the first direction of travel through the road junction can be a right turn from the southbound lane 148 of Avenue B 110 to the westbound lane 136 of Second Street 104, (4) the second direction of travel through the road junction can be straight along the southbound lane 148 of Avenue B 110, (5) the third direction of travel through the road junction can be a left turn from the eastbound lane 138 of Second Street 104 to the northbound lane 150 of Avenue B 110, (6) the fourth direction of travel through the road junction can be straight along the northbound lane 150 of Avenue B 110, (7) the fifth direction of travel through the road junction can be a right turn from the northbound lane 150 of Avenue B 110 to the eastbound lane 138 of Second Street 104, (8) the sixth direction of travel through the road junction can be a left turn from the westbound lane 136 of Second Street 104 to the southbound lane 148 of Avenue B 110, (9) the geographic position traces of the vehicles that traversed the first direction of travel through the road junction can include the fourth portion 180 of the fourth geographic position trace 164, (10) the geographic position traces of the vehicles that traversed the second direction of travel through the road junction can include: (a) the portion 168 of the first geographic position trace 158 and (b) the third portion 178 of the fourth geographic position trace 164, (11) the geographic position traces of the vehicles that traversed the third direction of travel through the road junction can include the portion 170 of the second geographic position trace 160, (12) the geographic position traces of the vehicles that traversed the fourth direction of travel through the road junction can include: (a) the portion 172 of the third geographic position trace 162 and (b) the first portion 174 of the fourth geographic position trace 164, (13) the geographic position traces of the vehicles that traversed the fifth direction of travel through the road junction can include the second portion 176 of the fourth geographic position trace 164, and (14) the geographic position traces of the vehicles that traversed the sixth direction of travel through the road junction can include the portion 182 of the fifth geographic position trace 166.

For example, if a lower threshold count is zero, then: (1) the count (i.e., one) of the geographic position traces of the vehicles that traversed the first direction of travel through the road junction, (2) the count (i.e., two) of the geographic position traces of the vehicles that traversed the second direction of travel through the road junction, (3) the count (i.e., one) of the geographic position traces of the vehicles that traversed the third direction of travel through the road junction, (4) the count (i.e., two) of the geographic position traces of the vehicles that traversed the fourth direction of travel through the road junction, (5) the count (i.e., one) of the geographic position traces of the vehicles that traversed the fifth direction of travel through the road junction, and (6) the count (i.e., one) of the geographic position traces of the vehicles that traversed the sixth direction of travel through the road junction, can each include enough data so that the digital map can be produced with a high degree of accuracy.

Moreover, for example, if an upper threshold count is three, then: (1) the count (i.e., one) of the geographic position traces of the vehicles that traversed the first direction of travel through the road junction, (2) the count (i.e., two) of the geographic position traces of the vehicles that traversed the second direction of travel through the road junction, (3) the count (i.e., one) of the geographic position traces of the vehicles that traversed the third direction of travel through the road junction, (4) the count (i.e., two) of the geographic position traces of the vehicles that traversed the fourth direction of travel through the road junction, (5) the count (i.e., one) of the geographic position traces of the vehicles that traversed the fifth direction of travel through the road junction, and (6) the count (i.e., one) of the geographic position traces of the vehicles that traversed the sixth direction of travel through the road junction, can each be within the limit on the amount of the data set so that the digital map can be produced in a relatively short duration of time).

In another implementation of the disclosed technologies, for example, the instructions to determine the set of the geographic position traces to be used to produce the digital map can include instructions to determine, using a greedy constraint optimization technique, the set of the geographic position traces to be used to produce the digital map.

For example, the aspect, in the region of interest, can include a first aspect and a second aspect. For example, the instructions to determine the set of the geographic position traces to be used to produce the digital map can include: (1) instructions to rank, among the geographic position traces of the vehicles that traversed the region of interest, the geographic position traces of the vehicles by length and (2) in an iterative manner starting with a geographic position trace, of the geographic position traces of the vehicles that traversed the region of interest, having a greatest length: (a) instructions to determine a first classification of a candidate geographic position trace, of the geographic position traces of the vehicles that traversed the region of interest, with respect to being affiliated with a traversal of a subject of the first aspect, (b) instructions to include, in response to the first classification being positive, the candidate geographic position trace in the set of geographic position traces to be used to produce the digital map, (c) instructions to determine a second classification of the candidate geographic position trace with respect to being affiliated with a traversal of a subject of the second aspect, and (d) instructions to include, in response to the second classification being positive, the candidate geographic position trace in the set of geographic position traces to be used to produce the digital map.

Additionally, for example, the count of the geographic position traces in the set can include a first count, for the first aspect, and a second count, for the second aspect. For example, the iterative manner can further include, in response to the candidate geographic position trace having been included in the set of geographic position traces: (1) instructions to increment the first count in response to the first classification being positive, (2) instructions to increment the second count in response to the second classification being positive, (3) instructions to continue the instructions to determine the first classification in response to the first count being less than a fifteenth threshold count, and (4) instructions to continue the instructions to determine the second classification in response to the second count being less than a sixteenth threshold count.

Additionally, for example, the iterative manner can further include: (5) instructions to cease the instructions to determine the first classification in response to the first count being equal to the fifteenth threshold count and (2) instructions to cease the instructions to determine the second classification in response to the second count being equal to the sixteenth threshold count.

With reference to FIG. 1, for example: (1) the region of interest can be the region of interest 156, (2) the first aspect can be the portion of Avenue B 110 south of the fifth road junction 122, but north of the eighth road junction 128, and (3) the second aspect can be: (a) the first direction of travel through the fifth road junction 122, (b) the second direction of travel through the fifth road junction 122, (c) the third direction of travel through the fifth road junction 122, (d) the fourth direction of travel through the fifth road junction 122, (e) the fifth direction of travel through the fifth road junction 122, and (f) the sixth direction of travel through the fifth road junction 122.

For example, a rank, among the geographic position traces of the vehicles that traversed the region of interest 14, the geographic position traces of the vehicles by length can be, from greatest length to least length: (1) the fourth geographic position trace 164, (2) the first geographic position trace 158, (3) the third geographic position trace 162, (4) the second geographic position trace 160, and (5) the fifth geographic position trace 166.

For example, in the iterative manner, starting with the fourth geographic position trace 164 with respect to being affiliated with a traversal of the subject of the first aspect, the first classification can be positive because: (1) the first portion 174 of the fourth geographic position trace 164 is affiliated with a traversal of the portion of Avenue B 110 south of the fifth road junction 122, but north of the eighth road junction 128, (2) the second portion 176 of the fourth geographic position trace 164 is affiliated with a traversal of the portion of Avenue B 110 south of the fifth road junction 122, but north of the eighth road junction 128, and (3) the third portion 178 of the fourth geographic position trace 164 is affiliated with a traversal of the portion of Avenue B 110 south of the fifth road junction 122, but north of the eighth road junction 128.

For example, if: (1) a lower threshold count for the first aspect is two and an upper threshold count for the first aspect is five and (2) a current count for the first aspect is zero, then because the count of: (1) the first portion 174 of the fourth geographic position trace 164, (2) the second portion 176 of the fourth geographic position trace 164, and (3) the third portion 178 of the fourth geographic position trace 164 is three and a sum of three added to zero is less than five: (1) the first portion 174 of the fourth geographic position trace 164, (2) the second portion 176 of the fourth geographic position trace 164, and (3) the third portion 178 of the fourth geographic position trace 164 can be included in the set of geographic position traces to be used to produce the digital map. Additionally, for example, the first count, for the first aspect, can be incremented to three.

For example, in the iterative manner, starting with the fourth geographic position trace 164 with respect to being affiliated with a traversal of the subject of the second aspect, the second classification can be positive because: (1) the fourth portion 180 of the fourth geographic position trace 164 is affiliated with a traversal of the first direction of travel through the fifth road junction 122, (2) the third portion 178 of the fourth geographic position trace 164 is affiliated with a traversal of the second direction of travel through the fifth road junction 122, (3) the first portion 174 of the fourth geographic position trace 164 is affiliated with a traversal of the fourth direction of travel through the fifth road junction 122, and (4) the second portion 176 of the fourth geographic position trace 164 is affiliated with a traversal of the fifth direction of travel through the fifth road junction 122.

For example, if: (1) a lower threshold count for each sub-aspect of the second aspect is zero and an upper threshold count for each sub-aspect of the second aspect is three and (2) a current count for each sub-aspect of the second aspect is zero, then because the count of each of: (1) the fourth portion 180 of the fourth geographic position trace 164 is one, (2) the third portion 178 of the fourth geographic position trace 164 is one, (3) the first portion 174 of the fourth geographic position trace 164 is one, and (4) the second portion 176 of the fourth geographic position trace 164 is one and a sum of one added to zero is less than three, each of: (1) the fourth portion 180 of the fourth geographic position trace 164, (2) the third portion 178 of the fourth geographic position trace 164, (3) the first portion 174 of the fourth geographic position trace 164, and (4) the second portion 176 of the fourth geographic position trace 164 can be included in the set of geographic position traces to be used to produce the digital map. Additionally, for example, the second count, for each of: (1) the first direction of travel through the fifth road junction 122, (2) the second direction of travel through the fifth road junction 122, (3) the fourth direction of travel through the fifth road junction 122, and (4) the fifth direction of travel through the fifth road junction 122 can be incremented to one.

For example, in the iterative manner, continuing with the first geographic position trace 158 with respect to being affiliated with a traversal of the subject of the first aspect, the first classification can be positive because the portion 168 of the first geographic position trace 158 is affiliated with a traversal of the portion of Avenue B 110 south of the fifth road junction 122, but north of the eighth road junction 128.

For example, if: (1) the lower threshold count for the first aspect is two and the upper threshold count for the first aspect is five and (2) the current count for the first aspect is three, then because the count of the portion 168 of the first geographic position trace 158 is one and a sum of one added to three is less than five, the portion 168 of the first geographic position trace 158 can be included in the set of geographic position traces to be used to produce the digital map. Additionally, for example, the first count, for the first aspect, can be incremented to four.

For example, in the iterative manner, continuing with the first geographic position trace 158 with respect to being affiliated with a traversal of the subject of the second aspect, the second classification can be positive because the portion 168 of the first geographic position trace 158 is affiliated with a traversal of the second direction of travel through the fifth road junction 122.

For example, if: (1) the lower threshold count for each sub-aspect of the second aspect is zero and the upper threshold count for each sub-aspect of the second aspect is three and (2) the current count for: (a) the first direction of travel through the fifth road junction 122 is one, (b) the second direction of travel through the fifth road junction 122 is one, (c) the third direction of travel through the fifth road junction 122 is zero, (d) the fourth direction of travel through the fifth road junction 122 is one, (e) the fifth direction of travel through the fifth road junction 122 is one, and (f) the sixth direction of travel through the fifth road junction 122 is zero, then because the count of the portion 168 of the first geographic position trace 158 is one and a sum of one added to one is less than three, the portion 168 of the first geographic position trace 158 can be included in the set of geographic position traces to be used to produce the digital map. Additionally, for example, the second count, for the second direction of travel through the fifth road junction 122 can be incremented to two.

For example, in the iterative manner, continuing with the third geographic position trace 162 with respect to being affiliated with a traversal of the subject of the first aspect, the first classification can be positive because the portion 172 of the third geographic position trace 162 is affiliated with a traversal of the portion of Avenue B 110 south of the fifth road junction 122, but north of the eighth road junction 128.

For example, if: (1) the lower threshold count for the first aspect is two and the upper threshold count for the first aspect is five and (2) the current count for the first aspect is four, then because the count of the portion 172 of the third geographic position trace 162 is one and a sum of one added to four is equal to five, the portion 172 of the third geographic position trace 162 can be excluded from the set of geographic position traces to be used to produce the digital map and the iterative manner, with respect to determinations of the first classification, can be ceased.

For example, in the iterative manner, continuing with the third geographic position trace 162 with respect to being affiliated with a traversal of the subject of the second aspect, the second classification can be positive because the portion 172 of the third geographic position trace 162 is affiliated with a traversal of the fourth direction of travel through the fifth road junction 122.

For example, if: (1) the lower threshold count for each sub-aspect of the second aspect is zero and the upper threshold count for each sub-aspect of the second aspect is three and (2) the current count for: (a) the first direction of travel through the fifth road junction 122 is one, (b) the second direction of travel through the fifth road junction 122 is one, (c) the third direction of travel through the fifth road junction 122 is zero, (d) the fourth direction of travel through the fifth road junction 122 is one, (e) the fifth direction of travel through the fifth road junction 122 is two, and (f) the sixth direction of travel through the fifth road junction 122 is zero, then because the count of the portion 172 of the third geographic position trace 162 is one and a sum of one added to one is less than three, the portion 172 of the third geographic position trace 162 can be included in the set of geographic position traces to be used to produce the digital map. Additionally, for example, the second count, for the fourth direction of travel through the fifth road junction 122 can be incremented to two.

For example, in the iterative manner, continuing with the second geographic position trace 160 with respect to being affiliated with a traversal of the subject of the second aspect, the second classification can be positive because the portion 170 of the second geographic position trace 160 is affiliated with a traversal of the third direction of travel through the fifth road junction 122.

For example, if: (1) the lower threshold count for each sub-aspect of the second aspect is zero and the upper threshold count for each sub-aspect of the second aspect is three and (2) the current count for: (a) the first direction of travel through the fifth road junction 122 is one, (b) the second direction of travel through the fifth road junction 122 is one, (c) the third direction of travel through the fifth road junction 122 is zero, (d) the fourth direction of travel through the fifth road junction 122 is two, (e) the fifth direction of travel through the fifth road junction 122 is two, and (f) the sixth direction of travel through the fifth road junction 122 is zero, then because the count of the portion 170 of the second geographic position trace 160 is one and a sum of one added to zero is less than three, the portion 170 of the second geographic position trace 160 can be included in the set of geographic position traces to be used to produce the digital map. Additionally, for example, the second count, for the third direction of travel through the fifth road junction 122 can be incremented to one.

For example, in the iterative manner, continuing with the fifth geographic position trace 166 with respect to being affiliated with a traversal of the subject of the second aspect, the second classification can be positive because the portion 182 of the fifth geographic position trace 166 is affiliated with a traversal of the sixth direction of travel through the fifth road junction 122.

For example, if: (1) the lower threshold count for each sub-aspect of the second aspect is zero and the upper threshold count for each sub-aspect of the second aspect is three and (2) the current count for: (a) the first direction of travel through the fifth road junction 122 is one, (b) the second direction of travel through the fifth road junction 122 is one, (c) the third direction of travel through the fifth road junction 122 is one, (d) the fourth direction of travel through the fifth road junction 122 is two, (e) the fifth direction of travel through the fifth road junction 122 is two, and (f) the sixth direction of travel through the fifth road junction 122 is zero, then because the count of the portion 182 of the fifth geographic position trace 166 is one and a sum of one added to zero is less than three, the portion 182 of the fifth geographic position trace 166 can be included in the set of geographic position traces to be used to produce the digital map. Additionally, for example, the second count, for the sixth direction of travel through the fifth road junction 122 can be incremented to one.

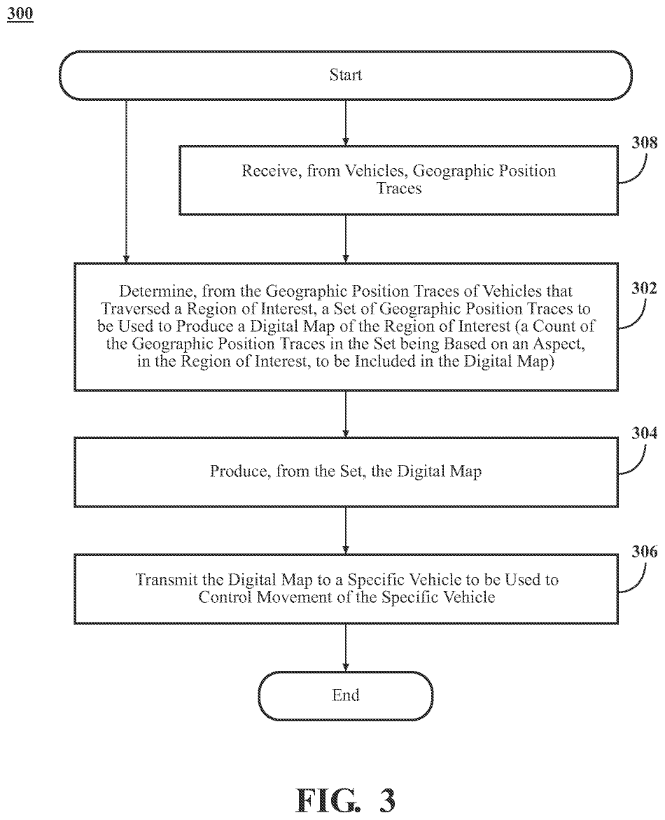

FIG. 3 includes a flow diagram that illustrates an example of a method 300 that is associated with determining a set of geographic position traces to be used to produce a digital map of a region of interest, according to the disclosed technologies. Although the method 300 is described in combination with the system 200 illustrated in FIG. 2, one of skill in the art understands, in light of the description herein, that the method 300 is not limited to being implemented by the system 200 illustrated in FIG. 2. Rather, the system 200 illustrated in FIG. 2 is an example of a system that may be used to implement the method 300. Additionally, although the method 300 is illustrated as a generally serial process, various aspects of the method 300 may be able to be executed in parallel.

In FIG. 3, in the method 300, at an operation 302, for example, the set determination module 206 can determine, from the geographic position traces of vehicles that traversed the region of interest, the set of the geographic position traces to be used to produce the digital map of the region of interest. For example, a count of the geographic position traces in the set can be based on an aspect, in the region of interest, to be included in the digital map.

At an operation 304, for example, the production module 208 can produce, from the set of the geographic position traces, the digital map.

At an operation 306, for example, the communications module 210 can transmit the digital map to a specific vehicle to be used to control movement of the specific vehicle.

For example, a geographic position trace, of the geographic position traces: (1) can be for a vehicle of the vehicles that traversed the region of interest and (2) can include a recording of a sequence of points. For example, the recording can include, for a point in the sequence of points, information about: (1) a position of the point and (2) a time at which the position was documented. For example, the position of the point can be expressed as a latitude of the point and a longitude of the point. For example, the position of the point can be a position of a camera disposed on the vehicle. Additionally, for example, the recording can further include, for the point, information about a height of the point with respect to a reference height. For example, the reference height can be sea level. For example, the position of the point can be determined from proprioception information affiliated with the vehicle. For example, the proprioception information can include one or more of global navigation satellite system (GNSS) information, inertial measurement unit (IMU) information, odometry information, or the like. For example, the sequence of points can include: (1) a first point as a first element and (2) a second point as a second element. For example, the sequence of points can be characterized by a duration of time between the first element and the second element. For example, the second element can be an element, in the sequence of points, that immediately follows the first element. For example, the duration of time can be affiliated with a specific production rate. For example, the specific production rate can be ten hertz.

Additionally, at an operation 308, for example, the communications module 210 can receive, from the vehicle, the geographic position trace. For example, the geographic position trace can include a sequence of geographic position traces. For example, the sequence of geographic position traces can include: (1) a first geographic position trace as a first element and (2) a second geographic position trace as a second element. For example, the second element can be an element, in the sequence of geographic position traces, that immediately follows the first element. For example, the instructions to receive the geographic position trace can include instructions to receive, at a specific communication rate, the sequence of geographic position traces. For example, the specific communication rate can be once per thirty seconds.

In an implementation of the disclosed technologies, for example, the aspect, in the region of interest, can include a first road. For example, the set of the geographic position traces to be used to produce the digital map can include the geographic position traces of the vehicles that traversed the first road. For example, the count of the geographic position traces in the set can be a count of the geographic position traces of the vehicles that traversed the first road. For example, the count of the geographic position traces of the vehicles that traversed the first road can be greater than a first threshold count (i.e., to include enough data so that the digital map can be produced with a high degree of accuracy). Additionally, for example, the count of the geographic position traces of the vehicles that traversed the first road can be less than a second threshold count (i.e., to set a limit on an amount of the data so that the digital map can be produced in a relatively short duration of time).

For example, a geographic position trace: (1) can be included in the set of the geographic position traces and (2) can include a sequence of geographic position traces. For example, the sequence of geographic position traces can include a first geographic position trace and a second geographic position trace. For example, the first geographic position trace can be affiliated with a traversal during a first duration of time. For example, the second geographic position trace can be affiliated with a traversal during a second duration of time. For example, the second duration of time can lack an overlap with the first duration of time. For example, the count of the geographic position traces in the set can include: (1) the first geographic position trace as one count and (2) the second geographic position trace as another count.

Additionally, for example, the aspect, in the region of interest, can further include: (1) a first lane of the first road and (2) a second lane of the first road. For example, the geographic position traces of the vehicles that traversed the first road can include a first subset and a second subset. For example, the first subset can include the geographic position traces of the vehicles that traversed the first lane. For example, the second subset can include the geographic position traces of the vehicles that traversed the second lane. For example, the count of the geographic position traces of the vehicles that traversed the first road can include a first count subset and a second count subset. For example, the first count subset can be a count of the geographic position traces of the vehicles that traversed the first lane. For example, the second count subset can be a count of the geographic position traces of the vehicles that traversed the second lane. For example, the count of the geographic position traces of the vehicles that traversed the first lane can be greater than a third threshold count. For example, the count of the geographic position traces of the vehicles that traversed the second lane can be greater than a fourth threshold count. For example, the fourth threshold count can be equal to the third threshold count. Additionally, for example, the count of the geographic position traces of the vehicles that traversed the first lane can be less than a fifth threshold count. Additionally, for example, the count of the geographic position traces of the vehicles that traversed the second lane can be less than a sixth threshold count. For example, the sixth threshold count can be equal to the fifth threshold count.

Alternatively or additionally, for example, the aspect, in the region of interest, can further include a road junction of the first road and a second road. For example, the geographic position traces of the vehicles that traversed the first road can include a subset. For example, the subset can include the geographic position traces of the vehicles that traversed the road junction. For example, the count of the geographic position traces of the vehicles that traversed the first road can include a count subset. For example, the count subset can be a count of the geographic position traces of the vehicles that traversed the road junction. For example, the count of the geographic position traces of the vehicles that traversed the road junction can be greater than a seventh threshold count. Additionally, for example, the count of the geographic position traces of the vehicles that traversed the first lane can be less than an eighth threshold count.

Additionally, for example, the aspect, in the region of interest, can further include: (1) a first direction of travel through the road junction and (2) a second direction of travel through the road junction. For example, the geographic position traces of the vehicles that traversed the road junction can include a first sub-subset and a second sub-subset. For example, the first sub-subset can include the geographic position traces of the vehicles that traversed the first direction of travel through the road junction. For example, the second sub-subset can include the geographic position traces of the vehicles that traversed the second direction of travel through the road junction. For example, the count of the geographic position traces of the vehicles that traversed the road junction can include a first count sub-subset and a second count sub-subset. For example, the first count sub-subset can be a count of the geographic position traces of the vehicles that traversed the first direction of travel through the road junction. For example, the second count sub-subset can be a count of the geographic position traces of the vehicles that traversed the second direction of travel through the road junction. For example, the count of the geographic position traces of the vehicles that traversed the first direction of travel through the road junction can be greater than a ninth threshold count. For example, the count of the geographic position traces of the vehicles that traversed the second direction of travel through the road junction can be greater than a tenth threshold count. For example, the tenth threshold count can be equal to the ninth threshold count. Additionally, for example, the count of the geographic position traces of the vehicles that traversed the first direction of travel through the road junction can be less than an eleventh threshold count. Additionally, for example, the count of the geographic position traces of the vehicles that traversed the second direction of travel through the road junction can be less than a twelfth threshold count. For example, the twelfth threshold count can be equal to the eleventh threshold count.

Additionally, for example, the aspect, in the region of interest, can further include a third direction of travel through the road junction. For example, the geographic position traces of the vehicles that traversed the road junction can further include a third sub-subset. For example, the third sub-subset can include the geographic position traces of the vehicles that traversed the third direction of travel through the road junction. For example, the count of the geographic position traces of the vehicles that traversed the road junction can further include a third count sub-subset. For example, the third count sub-subset can be a count of the geographic position traces of the vehicles that traversed the third direction of travel through the road junction. For example, the count of the geographic position traces of the vehicles that traversed the third direction of travel through the road junction can be greater than a thirteenth threshold count. For example, thirteenth threshold count can be equal to the ninth threshold count and the tenth threshold count. Additionally, for example, the count of the geographic position traces of the vehicles that traversed the third direction of travel through the road junction can be less than a fourteenth threshold count. For example, fourteenth threshold count can be equal to the eleventh threshold count and the twelfth threshold count.

In another implementation of the disclosed technologies, for example, at the operation 302, the set determination module 206 can determine, using a greedy constraint optimization technique, the set of the geographic position traces to be used to produce the digital map.

For example, the aspect, in the region of interest, can include a first aspect and a second aspect. For example, at the operation 302, the set determination module 206 can: (1) rank, among the geographic position traces of the vehicles that traversed the region of interest, the geographic position traces of the vehicles by length and (2) in an iterative manner starting with a geographic position trace, of the geographic position traces of the vehicles that traversed the region of interest, having a greatest length: (a) determine a first classification of a candidate geographic position trace, of the geographic position traces of the vehicles that traversed the region of interest, with respect to being affiliated with a traversal of a subject of the first aspect, (b) include, in response to the first classification being positive, the candidate geographic position trace in the set of geographic position traces to be used to produce the digital map, (c) determine a second classification of the candidate geographic position trace with respect to being affiliated with a traversal of a subject of the second aspect, and (d) include, in response to the second classification being positive, the candidate geographic position trace in the set of geographic position traces to be used to produce the digital map.

Additionally, for example, the count of the geographic position traces in the set can include a first count, for the first aspect, and a second count, for the second aspect. For example, at the operation 302, the iterative manner can further, in response to the candidate geographic position trace having been included in the set of geographic position traces: (1) increment the first count in response to the first classification being positive, (2) increment the second count in response to the second classification being positive, (3) continue to determine the first classification in response to the first count being less than a fifteenth threshold count, and (4) continue to determine the second classification in response to the second count being less than a sixteenth threshold count.

Additionally, for example, at the operation 302, the iterative manner can further: (5) cease to determine the first classification in response to the first count being equal to the fifteenth threshold count and (2) cease to determine the second classification in response to the second count being equal to the sixteenth threshold count.

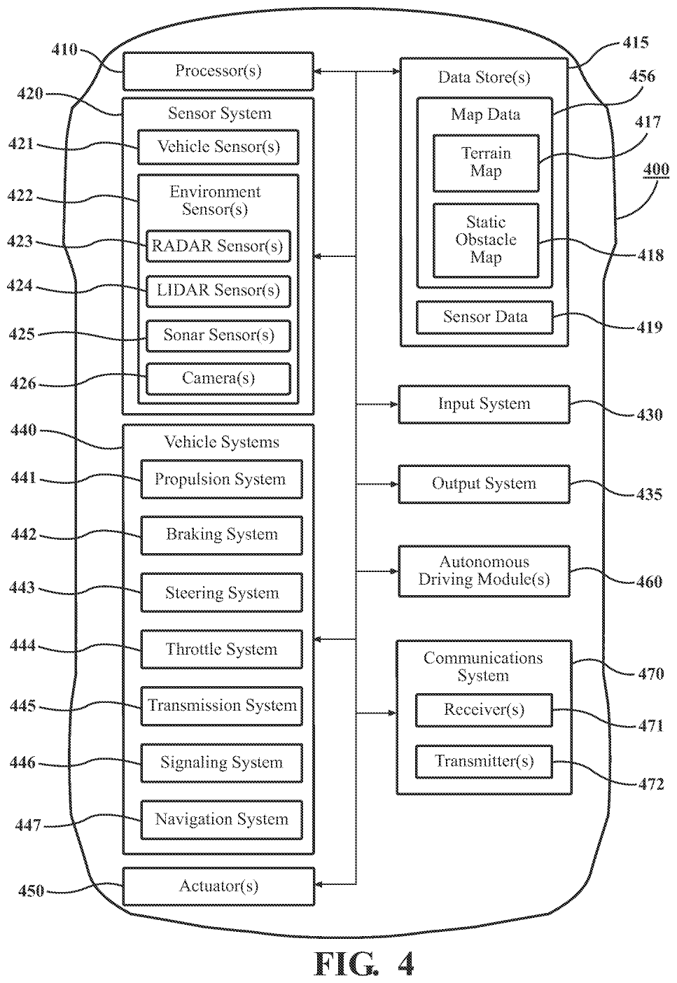

FIG. 4 includes a block diagram that illustrates an example of elements disposed on a vehicle 400, according to the disclosed technologies. As used herein, a “vehicle” can be any form of powered transport. In one or more implementations, the vehicle 400 can be an automobile. While arrangements described herein are with respect to automobiles, one of skill in the art understands, in light of the description herein, that embodiments are not limited to automobiles.

In some embodiments, the vehicle 400 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 400 is performed according to inputs received from a user (e.g., human driver). In one or more arrangements, the vehicle 400 can be a conventional vehicle that is configured to operate in only a manual mode.

In one or more embodiments, the vehicle 400 can be an automated vehicle. As used herein, “automated vehicle” can refer to a vehicle that operates in an automated mode. As used herein, “automated mode” can refer to navigating and/or maneuvering the vehicle 400 along a travel route using one or more computing systems to control the vehicle 400 with minimal or no input from a human driver. In one or more embodiments, the vehicle 400 can be highly automated or completely automated. In one embodiment, the vehicle 400 can be configured with one or more semi-automated operational modes in which one or more computing systems perform a portion of the navigation and/or maneuvering of the vehicle along a travel route, and a vehicle operator (i.e., driver) provides inputs to the vehicle 400 to perform a portion of the navigation and/or maneuvering of the vehicle 400 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 400 can include various elements. The vehicle 400 can have any combination of the various elements illustrated in FIG. 4. In various embodiments, it may not be necessary for the vehicle 400 to include all of the elements illustrated in FIG. 4. Furthermore, the vehicle 400 can have elements in addition to those illustrated in FIG. 4. While the various elements are illustrated in FIG. 4 as being located within the vehicle 400, one or more of these elements can be located external to the vehicle 400. Furthermore, the elements illustrated may be physically separated by large distances. For example, as described, one or more components of the disclosed system can be implemented within the vehicle 400 while other components of the system can be implemented within a cloud-computing environment, as described below. For example, the elements can include one or more processors 410, one or more data stores 415, a sensor system 420, an input system 430, an output system 435, vehicle systems 440, one or more actuators 450, one or more automated driving modules 460, and a communications system 470.

In one or more arrangements, the one or more processors 410 can be a main processor of the vehicle 400. For example, the one or more processors 410 can be an electronic control unit (ECU).

The one or more data stores 415 can store, for example, one or more types of data. The one or more data stores 415 can include volatile memory and/or non-volatile memory. Examples of suitable memory for the one or more data stores 415 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 415 can be a component of the one or more processors 410. Additionally or alternatively, the one or more data stores 415 can be operatively connected to the one or more processors 410 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

In one or more arrangements, the one or more data stores 415 can store map data 416. The map data 416 can include maps of one or more geographic areas. In some instances, the map data 416 can include information or data on roads, traffic control devices, road markings, structures, features, and/or landmarks in the one or more geographic areas. The map data 416 can be in any suitable form. In some instances, the map data 416 can include aerial views of an area. In some instances, the map data 416 can include ground views of an area, including 360-degree ground views. The map data 416 can include measurements, dimensions, distances, and/or information for one or more items included in the map data 416 and/or relative to other items included in the map data 416. The map data 416 can include a digital map with information about road geometry. The map data 416 can be high quality and/or highly detailed.

In one or more arrangements, the map data 416 can include one or more terrain maps 417. The one or more terrain maps 417 can include information about the ground, terrain, roads, surfaces, and/or other features of one or more geographic areas. The one or more terrain maps 417 can include elevation data of the one or more geographic areas. The map data 416 can be high quality and/or highly detailed. The one or more terrain maps 417 can define one or more ground surfaces, which can include paved roads, unpaved roads, land, and other things that define a ground surface.

In one or more arrangements, the map data 416 can include one or more static obstacle maps 418. The one or more static obstacle maps 418 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 418 can have location data, size data, dimension data, material data, and/or other data associated with them. The one or more static obstacle maps 418 can include measurements, dimensions, distances, and/or information for one or more static obstacles. The one or more static obstacle maps 418 can be high quality and/or highly detailed. The one or more static obstacle maps 418 can be updated to reflect changes within a mapped area.

In one or more arrangements, the one or more data stores 415 can store sensor data 419. As used herein, “sensor data” can refer to any information about the sensors with which the vehicle 400 can be equipped including the capabilities of and other information about such sensors. The sensor data 419 can relate to one or more sensors of the sensor system 420. For example, in one or more arrangements, the sensor data 419 can include information about one or more lidar sensors 424 of the sensor system 420.

In some arrangements, at least a portion of the map data 416 and/or the sensor data 419 can be located in one or more data stores 415 that are located onboard the vehicle 400. Additionally or alternatively, at least a portion of the map data 416 and/or the sensor data 419 can be located in one or more data stores 415 that are located remotely from the vehicle 400.

The sensor system 420 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 420 includes a plurality of sensors, the sensors can work independently from each other. Alternatively, two or more of the sensors can work in combination with each other. In such a case, the two or more sensors can form a sensor network. The sensor system 420 and/or the one or more sensors can be operatively connected to the one or more processors 410, the one or more data stores 415, and/or another element of the vehicle 400 (including any of the elements illustrated in FIG. 4). The sensor system 420 can acquire data of at least a portion of the external environment of the vehicle 400 (e.g., nearby vehicles). The sensor system 420 can include any suitable type of sensor. Various examples of different types of sensors are described herein. However, one of skill in the art understands that the embodiments are not limited to the particular sensors described herein.

The sensor system 420 can include one or more vehicle sensors 421. The one or more vehicle sensors 421 can detect, determine, and/or sense information about the vehicle 400 itself. In one or more arrangements, the one or more vehicle sensors 421 can be configured to detect and/or sense position and orientation changes of the vehicle 400 such as, for example, based on inertial acceleration. In one or more arrangements, the one or more vehicle sensors 421 can include one or more accelerometers, one or more gyroscopes, an inertial measurement unit (IMU), a dead-reckoning system, a global navigation satellite system (GNSS), a global positioning system (GPS), a navigation system 447, and/or other suitable sensors. The one or more vehicle sensors 421 can be configured to detect and/or sense one or more characteristics of the vehicle 400. In one or more arrangements, the one or more vehicle sensors 421 can include a speedometer to determine a current speed of the vehicle 400.

Additionally or alternatively, the sensor system 420 can include one or more environment sensors 422 configured to acquire and/or sense driving environment data. As used herein, “driving environment data” can include data or information about the external environment in which a vehicle is located or one or more portions thereof. For example, the one or more environment sensors 422 can be configured to detect, quantify, and/or sense obstacles in at least a portion of the external environment of the vehicle 400 and/or information/data about such obstacles. Such obstacles may be stationary objects and/or dynamic objects. The one or more environment sensors 422 can be configured to detect, measure, quantify, and/or sense other things in the external environment of the vehicle 400 such as, for example, lane markers, signs, traffic lights, traffic signs, lane lines, crosswalks, curbs proximate the vehicle 400, off-road objects, etc.

Various examples of sensors of the sensor system 420 are described herein. The example sensors may be part of the one or more vehicle sensors 421 and/or the one or more environment sensors 422. However, one of skill in the art understands that the embodiments are not limited to the particular sensors described.

In one or more arrangements, the one or more environment sensors 422 can include one or more radar sensors 423, one or more lidar sensors 424, one or more sonar sensors 425, and/or one more cameras 426. In one or more arrangements, the one or more cameras 426 can be one or more high dynamic range (HDR) cameras or one or more infrared (IR) cameras. For example, the one or more cameras 426 can be used to record a reality of a state of an item of information that can appear in the digital map.

The input system 430 can include any device, component, system, element, arrangement, or groups thereof that enable information/data to be entered into a machine. The input system 430 can receive an input from a vehicle passenger (e.g., a driver or a passenger). The output system 435 can include any device, component, system, element, arrangement, or groups thereof that enable information/data to be presented to a vehicle passenger (e.g., a driver or a passenger).

Various examples of the one or more vehicle systems 440 are illustrated in FIG. 4. However, one of skill in the art understands that the vehicle 400 can include more, fewer, or different vehicle systems. Although particular vehicle systems can be separately defined, each or any of the systems or portions thereof may be otherwise combined or segregated via hardware and/or software within the vehicle 400. For example, the one or more vehicle systems 440 can include a propulsion system 441, a braking system 442, a steering system 443, a throttle system 444, a transmission system 445, a signaling system 446, and/or the navigation system 447. Each of these systems can include one or more devices, components, and/or a combination thereof, now known or later developed.

The navigation system 447 can include one or more devices, applications, and/or combinations thereof, now known or later developed, configured to determine the geographic location of the vehicle 400 and/or to determine a travel route for the vehicle 400. The navigation system 447 can include one or more mapping applications to determine a travel route for the vehicle 400. The navigation system 447 can include a global positioning system, a local positioning system, a geolocation system, and/or a combination thereof.

The one or more actuators 450 can be any element or combination of elements operable to modify, adjust, and/or alter one or more of the vehicle systems 440 or components thereof responsive to receiving signals or other inputs from the one or more processors 410 and/or the one or more automated driving modules 460. Any suitable actuator can be used. For example, the one or more actuators 450 can include motors, pneumatic actuators, hydraulic pistons, relays, solenoids, and/or piezoelectric actuators.

The one or more processors 410 and/or the one or more automated driving modules 460 can be operatively connected to communicate with the various vehicle systems 440 and/or individual components thereof. For example, the one or more processors 410 and/or the one or more automated driving modules 460 can be in communication to send and/or receive information from the various vehicle systems 440 to control the movement, speed, maneuvering, heading, direction, etc. of the vehicle 400. The one or more processors 410 and/or the one or more automated driving modules 460 may control some or all of these vehicle systems 440 and, thus, may be partially or fully automated.

The one or more processors 410 and/or the one or more automated driving modules 460 may be operable to control the navigation and/or maneuvering of the vehicle 400 by controlling one or more of the vehicle systems 440 and/or components thereof. For example, when operating in an automated mode, the one or more processors 410 and/or the one or more automated driving modules 460 can control the direction and/or speed of the vehicle 400. The one or more processors 410 and/or the one or more automated driving modules 460 can cause the vehicle 400 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner. The communications system 470 can include one or more receivers 471 and/or one or more transmitters 472. The communications system 470 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 470 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 410, the one or more data stores 415, and the communications system 470 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 400 can include one or more modules, at least some of which are described herein. The modules can be implemented as computer-readable program code that, when executed by the one or more processors 410, implement one or more of the various processes described herein. One or more of the modules can be a component of the one or more processors 410. Additionally or alternatively, one or more of the modules can be executed on and/or distributed among other processing systems to which the one or more processors 410 can be operatively connected. The modules can include instructions (e.g., program logic) executable by the one or more processors 410. Additionally or alternatively, the one or more data store 415 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 400 can include one or more automated driving modules 460. The one or more automated driving modules 460 can be configured to receive data from the sensor system 420 and/or any other type of system capable of capturing information relating to the vehicle 400 and/or the external environment of the vehicle 400. In one or more arrangements, the one or more automated driving modules 460 can use such data to generate one or more driving scene models. The one or more automated driving modules 460 can determine position and velocity of the vehicle 400. The one or more automated driving modules 460 can determine the location of obstacles, obstacles, or other environmental features including traffic signs, trees, shrubs, neighboring vehicles, pedestrians, etc.

The one or more automated driving modules 460 can be configured to receive and/or determine location information for obstacles within the external environment of the vehicle 400 for use by the one or more processors 410 and/or one or more of the modules described herein to estimate position and orientation of the vehicle 400, vehicle position in global coordinates based on signals from a plurality of satellites, or any other data and/or signals that could be used to determine the current state of the vehicle 400 or determine the position of the vehicle 400 with respect to its environment for use in either creating a map or determining the position of the vehicle 400 in respect to map data.

The one or more automated driving modules 460 can be configured to determine one or more travel paths, current automated driving maneuvers for the vehicle 400, future automated driving maneuvers and/or modifications to current automated driving maneuvers based on data acquired by the sensor system 420, driving scene models, and/or data from any other suitable source such as determinations from the sensor data 419. As used herein, “driving maneuver” can refer to one or more actions that affect the movement of a vehicle. Examples of driving maneuvers include: accelerating, decelerating, braking, turning, moving in a lateral direction of the vehicle 400, changing travel lanes, merging into a travel lane, and/or reversing, just to name a few possibilities. The one or more automated driving modules 460 can be configured to implement determined driving maneuvers. The one or more automated driving modules 460 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 460 can be configured to execute various vehicle functions and/or to transmit data to, receive data from, interact with, and/or control the vehicle 400 or one or more systems thereof (e.g., one or more of vehicle systems 440). For example, functions and/or operations of an automotive navigation system can be realized by the one or more automated driving modules 460.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-4, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
a set determination module including instructions that, when executed by the processor, cause the processor to determine, from geographic position traces of vehicles that traversed a region of interest, a set of geographic position traces to be used to produce a digital map of the region of interest, wherein a count of the geographic position traces in the set is based on an aspect, in the region of interest, to be included in the digital map;
a production module including instructions that, when executed by the processor, cause the processor to produce, from the set, the digital map; and
a communications module including instructions that, when executed by the processor, cause the processor to transmit the digital map to a specific vehicle to be used to control movement of the specific vehicle.

2. The system of claim 1, wherein a geographic position trace, of the geographic position traces:
is for a vehicle of the vehicles that traversed the region of interest, and
comprises a recording of a sequence of points, wherein the recording includes, for a point in the sequence of points, information about:
a position of the point, and
a time at which the position was documented.

3. The system of claim 2, wherein the recording further includes, for the point, information about a height of the point with respect to a reference height.

4. The system of claim 2, wherein the position is determined from proprioception information affiliated with the vehicle.

5. The system of claim 4, wherein the proprioception information comprises at least one of global navigation satellite system information, inertial measurement unit information, or odometry information.

6. The system of claim 2, wherein the sequence of points:
includes a first point as a first element,
includes a second point as a second element,
is characterized by a duration of time between the first element and the second element, the second element being an element, in the sequence of points, that immediately follows the first element.

7. The system of claim 2, wherein the communications module further includes instructions to receive, from the vehicle, the geographic position trace.

8. The system of claim 2, wherein:
the aspect, in the region of interest, includes a first road,
the set of the geographic position traces to be used to produce the digital map includes the geographic position traces of the vehicles that traversed the first road, and
the count of the geographic position traces in the set is a count of the geographic position traces of the vehicles that traversed the first road, and
the count of the geographic position traces of the vehicles that traversed the first road is greater than a first threshold count.

9. The system of claim 8, wherein the count of the geographic position traces of the vehicles that traversed the first road is less than a second threshold count.

10. The system of claim 8, wherein:
the geographic position trace:
is included in the set of the geographic position traces, and
comprises a sequence of geographic position traces,
the sequence of geographic position traces includes a first geographic position trace and a second geographic position trace,
the first geographic position trace is affiliated with a traversal during a first duration of time,
the second geographic position trace is affiliated with a traversal during a second duration of time, the second duration of time lacking an overlap with the first duration of time, and
the count of the geographic position traces in the set includes:
the first geographic position trace as one count, and
the second geographic position trace as another count.

11. The system of claim 8, wherein:
the aspect further includes:
a first lane of the first road, and
a second lane of the first road,
the geographic position traces of the vehicles that traversed the first road includes a first subset and a second subset,
the first subset includes the geographic position traces of the vehicles that traversed the first lane,
the second subset includes the geographic position traces of the vehicles that traversed the second lane,
the count of the geographic position traces of the vehicles that traversed the first road includes a first count subset and a second count subset,
the first count subset is a count of the geographic position traces of the vehicles that traversed the first lane,
the second count subset is a count of the geographic position traces of the vehicles that traversed the second lane,
the count of the geographic position traces of the vehicles that traversed the first lane is greater than a second threshold count, and
the count of the geographic position traces of the vehicles that traversed the second lane is greater than a third threshold count.

12. The system of claim 8, wherein:
the aspect further includes a road junction of the first road and a second road,
the geographic position traces of the vehicles that traversed the first road includes a subset,
the subset includes the geographic position traces of the vehicles that traversed the road junction,
the count of the geographic position traces of the vehicles that traversed the first road includes a count subset,
the count subset is a count of the geographic position traces of the vehicles that traversed the road junction, and
the count of the geographic position traces of the vehicles that traversed the road junction is greater than a second threshold count.

13. The system of claim 12, wherein:
the aspect further includes:
a first direction of travel through the road junction, and
a second direction of travel through the road junction,
the geographic position traces of the vehicles that traversed the road junction includes a first sub-subset and a second sub-subset,
the first sub-subset includes the geographic position traces of the vehicles that traversed the first direction of travel through the road junction,
the second sub-subset includes the geographic position traces of the vehicles that traversed the second direction of travel through the road junction,
the count of the geographic position traces of the vehicles that traversed the road junction includes a first count sub-subset and a second count sub-subset,
the first count sub-subset is a count of the geographic position traces of the vehicles that traversed the first direction of travel through the road junction,
the second count sub-subset is a count of the geographic position traces of the vehicles that traversed the second direction of travel through the road junction,
the count of the geographic position traces of the vehicles that traversed the first direction of travel through the road junction is greater than a third threshold count, and
the count of the geographic position traces of the vehicles that traversed the second direction of travel through the road junction is greater than a fourth threshold count.

14. The system of claim 13, wherein:
the aspect further includes a third direction of travel through the road junction,
the geographic position traces of the vehicles that traversed the road junction further includes a third sub-subset,
the third sub-subset includes the geographic position traces of the vehicles that traversed the third direction of travel through the road junction,
the count of the geographic position traces of the vehicles that traversed the road junction further includes a third count sub-subset,
the third count sub-subset is a count of the geographic position traces of the vehicles that traversed the third direction of travel through the road junction, and
the count of the geographic position traces of the vehicles that traversed the third direction of travel through the road junction is greater than a fifth threshold count.

15. The system of claim 1, wherein the instructions to determine the set of the geographic position traces to be used to produce the digital map include instructions to determine, using a greedy constraint optimization technique, the set of the geographic position traces to be used to produce the digital map.

16. The system of claim 1, wherein:
the aspect, in the region of interest, comprises a first aspect and a second aspect, and
the instructions to determine the set of the geographic position traces to be used to produce the digital map include:
instructions to rank, among the geographic position traces of the vehicles that traversed the region of interest, the geographic position traces of the vehicles by length; and
in an iterative manner starting with a geographic position trace, of the geographic position traces of the vehicles that traversed the region of interest, having a greatest length:
instructions to determine a first classification of a candidate geographic position trace, of the geographic position traces of the vehicles that traversed the region of interest, with respect to being affiliated with a traversal of a subject of the first aspect;
instructions to include, in response to the first classification being positive, the candidate geographic position trace in the set of geographic position traces to be used to produce a digital map;
instructions to determine a second classification of the candidate geographic position trace with respect to being affiliated with a traversal of a subject of the second aspect; and
instructions to include, in response to the second classification being positive, the candidate geographic position trace in the set of geographic position traces to be used to produce a digital map.

17. The system of claim 16, wherein:
the count of the geographic position traces in the set comprises:
a first count for the first aspect, and
a second count for the second aspect, and
the iterative manner further comprises, in response to the candidate geographic position trace having been included in the set of geographic position traces:
instructions to increment the first count in response to the first classification being positive,
instructions to increment the second count in response to the second classification being positive,
instructions to continue the instructions to determine the first classification in response to the first count being less than a first threshold count, and
instructions to continue the instructions to determine the second classification in response to the second count being less than a second threshold count.

18. The system of claim 17, wherein the iterative manner further comprises:
instructions to cease the instructions to determine the first classification in response to the first count being equal to the first threshold count, and
instructions to cease the instructions to determine the second classification in response to the second count being equal to the second threshold count.

19. A method, comprising:
determining, by a processor and from geographic position traces of vehicles that traversed a region of interest, a set of geographic position traces to be used to produce a digital map of the region of interest, wherein a count of the geographic position traces in the set is based on an aspect, in the region of interest, to be included in the digital map;
producing, by the processor and from the set, the digital map; and
transmitting, by the processor, the digital map to a specific vehicle to be used to control movement of the specific vehicle.

20. A non-transitory computer-readable medium for determining a set of geographic position traces to be used to produce a digital map of a region of interest, the non-transitory computer-readable medium including instructions that, when executed by one or more processors, cause the one or more processors to:
determine, from geographic position traces of vehicles that traversed the region of interest, the set of geographic position traces to be used to produce the digital map of the region of interest, wherein a count of the geographic position traces in the set is based on an aspect, in the region of interest, to be included in the digital map;
produce, from the set, the digital map; and
transmit the digital map to a specific vehicle to be used to control movement of the specific vehicle.
